(19) United States
(12) Patent Application Publication
(10) Pub. No.: US 2024/0273525 A1
(43) Pub. Date: Aug. 15, 2024

(54) BLOCKCHAIN-BASED SYSTEMS AND METHODS FOR MANAGING DIGITAL CURRENCY

(71) Applicant: State Farm Mutual Automobile Insurance Company, Bloomington, IL (US)

(72) Inventors: Veena Vivek, Chandler, AZ (US); Jose I. Gutierrez, Laveen, AZ (US); Anthony Welcome, Mesa, AZ (US); Steve Amancha, Tempe, AZ (US); EllaKate LeFebre, Mesa, AZ (US); Kimberly C. Kloeppel, Mesa, AZ (US)

(21) Appl. No.: 18/442,918

(22) Filed: Feb. 15, 2024

Related U.S. Application Data
(60) Provisional application No. 63/485,217, filed on Feb. 15, 2023.

(51) Int. Cl. G06Q 20/38; G06Q 20/10; G06Q 20/36; G06Q 20/40

(52) U.S. Cl. CPC G06Q 20/389; G06Q 20/10; G06Q 20/367; G06Q 20/385; G06Q 20/401

(57) ABSTRACT

Blockchain-based systems and methods for managing digital currency associated with a company or organization are disclosed. The digital currency may be used to reward or incentivize behaviors of employees, clients, and/or prospective clients or customers of a company, organization, or other entity. A blockchain computing device in accordance with the present disclosure may include at least one memory and at least one processor in communication with the at least one memory. The processor may be programmed to, in response to a predetermined criterion being met, automatically generate a reward token transaction, broadcast the reward token transaction to a blockchain network, validate the reward token transaction, and generate and store a new block on the blockchain network with the reward token transaction.

### CROSS-REFERENCE TO RELATED APPLICATIONS

This application claims the benefit of priority to U.S. Provisional Patent Application No. 63/485,217 filed on Feb. 15, 2023, entitled “BLOCKCHAIN-BASED SYSTEMS AND METHODS FOR MANAGING DIGITAL CURRENCY,” the entire contents and disclosures of which are hereby incorporated by reference herein in their entirety.

### FIELD OF THE DISCLOSURE

The present disclosure generally relates to blockchain technology and digital currency, and more particularly, to blockchain-based systems and methods for managing digital currency associated with a company, organization, or other entity.

### BACKGROUND

Many organizations offer redemption opportunities for their employees, customers, or potential customers. For example, a person, such as an employee, customers, or potential customer, may receive loyalty points and/or rewards associated with an organization for performing an action. However, these loyalty points and/or rewards may be erased, canceled, or expired after a period of time. Further, these loyalty points and/or rewards may not be consistent across an enterprise and cannot be traded between users. Additionally, the loyalty points and/or rewards typically require administrative oversight.

Therefore, an automatic, flexible, and secure reward mechanism with more functionality is desirable. Conventional techniques may include other drawbacks, inefficiencies, ineffectiveness, and/or encumbrances, as well.

### BRIEF SUMMARY

The present embodiments may relate to blockchain-based systems and methods for managing digital currency associated with a company, an organization, or other entity. The digital currency may be used to reward or incentivize behaviors of employees, clients, and/or prospective clients of the company, organization, or other entity.

In one aspect, a blockchain-based computer system for managing reward tokens may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a blockchain computing device may include at least one memory and at least one processor in communication with the at least one memory. The processor may be programmed to: (1) receive an instruction to transfer reward tokens from one digital wallet to another; (2) generate a reward token transaction; (3) broadcast the reward token transaction to a blockchain network; (4) validate the reward token transaction; (5) generate and store a new block on the blockchain network with the reward token transaction; and/or (6) cause to be displayed on a user interface the reward token transaction. The computing device may include additional, less, or alternate functionality, including that discussed elsewhere herein.

In one aspect, a blockchain-based computer system for managing reward tokens may be provided. In some exemplary embodiments, the computer system includes at least one processor in communication with at least one memory device. The at least one processor may be programmed to access the blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block. In response to a predetermined criterion being met, the at least one processor may automatically generate a reward token transaction, the reward token transaction including transaction data comprising at least a wallet address of a sender, a wallet address of a receiver, and/or an amount of reward tokens. The at least one processor may be further configured to broadcast an update to the plurality of node computing devices of the blockchain network, the update including the reward token transaction, validate the reward token transaction, and in response to validation of the reward token transaction, generate and store a new block the blockchain network with the reward token transaction. The computer system may be configured with additional, less, or alternate functionality, including that discussed elsewhere herein.

In another aspect, a computer-implemented method for providing a reward program is provided. The method may be implemented using a blockchain-based computing device including at least one processor in communication with at least one memory device. The method may include accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block. In response to a predetermined criterion being met, the method may further comprise automatically generating a reward token transaction, the reward token transaction including transaction data comprising at least a wallet address of a sender, a wallet address of a receiver, and/or an amount of reward tokens. The method may further comprise broadcasting an update to the plurality of node computing devices of the blockchain network, the update including the reward token transaction, validating the reward token transaction, and in response to validation of the reward token transaction, generating and storing a new block the blockchain network with the reward token transaction. The method may include additional, less, or alternate actions, including those discussed elsewhere herein.

In yet another aspect, a least one non-transitory computer-readable media having computer-executable instructions thereon is provided. When executed by at least one processor of a blockchain-based computing device, the computer-executable instructions may cause the at least one processor of the computing device to access the blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block. In response to a predetermined criterion being met, the computer-executable instructions may cause the at least one processor may automatically generate a reward token transaction, the reward token transaction including transaction data comprising at least a wallet address of a sender, a wallet address of a receiver, and/or an amount of reward tokens. The computer-executable instructions may further cause the at least one processor to broadcast an update to the plurality of node computing devices of the blockchain network, the update including the reward token transaction, validate the reward token transaction, and in response to validation of the reward token transaction, generate and store a new block the blockchain network with the reward token transaction. The instructions may direct additional, less, or alternate operations or functionality, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. In addition, although certain steps of the exemplary processes are numbered, having such numbering does not indicate or imply that the steps necessarily have to be performed in the order listed. The steps may be performed in the order indicated or in another order. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a block diagram of an exemplary computing environment for implementing a reward program computer system for managing reward tokens, according to one embodiment of the present disclosure.

FIG. 2 is a block diagram of an exemplary blockchain associated with reward tokens that may be exchanged and stored using a plurality of blockchain nodes, according to one embodiment of the present disclosure.

FIG. 3 is an exemplary sequence diagram illustrating exemplary aspects of managing reward tokens using the reward program computing system of FIG. 1, according to one embodiment of the present disclosure.

FIG. 4 is a block diagram of an exemplary blockchain mining system, according to one embodiment of the present disclosure.

FIG. 5 is a flow diagram of an exemplary computer-implemented process for one aspect of managing reward tokens using the reward program computing system of FIG. 1, according to one embodiment of the present disclosure.

FIG. 6 is a diagram of an exemplary graphical user interface for managing reward tokens, according to one embodiment of the present disclosure.

FIG. 7 illustrates an exemplary configuration of an exemplary user computing device.

FIG. 8 illustrates an exemplary configuration of an exemplary server computing device.

FIG. 9 illustrates a flow chart of an exemplary computer-implemented method for the exemplary reward token system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The systems and methods described herein relate to, inter alia, blockchain-based systems and methods for managing digital currency associated with a company, an organization, or other entity. More particularly, the systems and methods described herein may related to systems and methods for managing reward tokens that are a part of a reward program associated with a company, organization, or other entity. In one exemplary embodiment, the process may be performed by a computer device associated with a user of the reward program, also known as an access computer device, in communication with a blockchain network. In some embodiments, a reward program computer system, including the access computer device and/or one or more blockchain node computing devices of the blockchain network, are configured to facilitate the issuing, exchanging, and redeeming of reward tokens. In some embodiments, the blockchain network may act as a digital wallet for storing, sending, and receiving reward tokens. In some embodiments, the reward tokens are associated with a particular company, organization, or other entity.

The reward program computer system described herein may include one or more blockchain node computing devices of a blockchain network, wherein the blockchain network provides an encrypted, distributed, and immutable ledger in which transaction information associated with a plurality of reward tokens are stored. Each blockchain node computing device stores a local, complete copy of the ledger as a plurality of blockchains. A blockchain is a distributed database that maintains a continuously growing list of ordered records, known as blocks. Each blockchain may include a sequence of one or more blocks, wherein each block is cryptographically verifiable and enforces a chronological order of data stored in subsequent blocks. In some embodiments, the one or more blocks may include a first block representing a first transaction associated with a reward token. The one or more blocks may include additional, subsequent blocks, each subsequent block after the first block including a description of data stored in the immediately preceding block and/or a link to the previous block. In some embodiments, each subsequent block in a blockchain may include transaction information associated each previous block.

Each block may contain at least a timestamp and a link to the previous block in the chain. The link to the previous block may be a hash of the previous block. For example, in the case of a reward token, the first block may contain a first transaction. The second block may contain a second transaction and a hashed copy of the first block. The third block may contain a third transaction and a hashed copy of the second block. This continues on with each block adding on to the next while containing a hash of the previous blocks in the blockchain.

In some embodiments, the data stored in the previous block and/or the link to the previous block may include a hash of data stored in the previous block. The hash (which may be referred as a “hash value”) may be generated by executing a hashing function on the data stored in the previous block. This continues on, with each block adding onto the next while containing a hash of the previous block(s) in the blockchain. In this way, the chronological series of data stored in a single blockchain may be verifiable and immutable. The reward program computer system may include and/or access at least one blockchain node computing device, thereby facilitating access to the distributed blockchain network through the at least one blockchain node computing device.

To ensure the security of the information contained in the blockchain, copies of the blockchain are distributed across multiple computer devices, known as nodes. These nodes maintain the blockchain, update the blockchain when changes occur, and ensure the stability of the blockchain itself. In some embodiments, nodes may also be used to calculate the hash of the previous blocks. As the blockchain grows, the processing power needed to calculate the hash of the previous blocks grows as well.

In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

In some embodiments, data stored in a block of a blockchain may be encrypted using any suitable encryption process(es), thereby improving the security of the data stored therein. In some embodiments, a block may include and/or otherwise provide access to a public key that enables decryption of encrypted data stored in the block. In other embodiments, a public key may be securely distributed to access computer device(s) that are verified to have entitlement access to the data within a block and/or within the blockchain network.

The blockchain network may function as a platform for issuing, exchanging, and redeeming reward tokens associated with an organization. In other words, the blockchain network may act as a digital wallet for reward tokens which are associated with an organization, a company or other entity.

In some embodiments, the blockchain network and reward tokens are private. For example, the blockchain network for issuing, exchanging, and redeeming reward tokens may be accessible by employees of an organization. In some embodiments, the blockchain network and reward tokens are semi-public. For example, the blockchain network for issuing, exchanging, and redeeming reward tokens may be clients of an organization.

In some embodiments, the blockchain network and reward tokens are public. For example, the blockchain network for issuing, exchanging, and redeeming reward tokens may be accessible by prospective clients of an organization or customers of an entity or other persons associated with an entity.

In some embodiments, blockchain network may be used to transfer reward tokens from one user to another user. In some embodiments, certain users may be designated reward token distributors. For example, a designated token distributor may be a manager or other leader within the company. These designated token distributors may award reward tokens to users in response to a desirable action by the user.

In some embodiments, each designated reward token distributor is given a number of reward tokens to distribute to users over a time period. For example, a manager or leader may be provided a number of reward tokens each year to distribute to employees of the company. The leaders and managers may reward tokens in response to a user achieving a goal, performing a desirable action, mentoring or assisting another user, outstanding work performance, and/or any other actions tied to employment that the organization would like to promote.

A reward token transaction is triggered automatically in response to one or more conditions being met, or may be triggered and distributed as part of a smart contract being executed. A “smart contract” may be computer code executable upon the satisfaction of one or more execution criteria. As will be explained further below, a smart contract may be based upon a blockchain structure. For example, the blockchain network may further function to store smart contracts that execute upon satisfaction of one or more execution criteria. Execution of the smart contract may automatically trigger a transfer of reward tokens (e.g., from an organization's administrative wallet to a user wallet).

In some embodiments the execution criteria are set forth by the organization and relate to an activity or event tied to employment. For example, with regard to a reward program that is internal to an organization, an automatic transfer of reward tokens from the organization's administrative wallet to an employee account may occur upon the employee completing a training program, reaching a work anniversary, achieving an objective performance goal, and/or any other objective criterion. In some embodiments, the reward program computing system receives the activity and event information relating to a smart contract from another computing device or database. Therefore, instead of an employee having to maintain a person list of past achievements, the blockchain network may do it for them.

Additionally, or alternatively, the reward program computing system receives the activity and event information relating to a smart contract from a user input. Further, an organization may automatically send reward tokens to employees upon the organization achieving an objective performance goal, on a certain date such as a holiday, completing a survey, completing a survey, and/or any number of other actions an organization would like to promote within their organization.

With regards to a reward program that is semi-public, an automatic transfer of reward tokens may occur upon behaviors that an organization would like to incentivize. For example, for reward programs that are open to clients of an organization, an automatic transfer of reward tokens from the organization's administrative wallet to a client wallet may occur upon the client registering for an online account, logging into their account a predetermined number of times over a time interval, downloading an application, completing a survey, and/or any number of other client actions an organization would like to promote.

With regards to a reward program that is public, an automatic transfer of reward tokens may occur upon behaviors that an organization would like to incentivize. For example, for reward programs that are open to prospective clients or customers of an organization, an automatic transfer of reward tokens from the organization's administrative wallet to a client wallet may occur upon someone providing personal information such as email address or phone number, signing up for an organization newsletter, signing up for an informational session for the organization, completing a survey, and/or any number of other prospective client actions an organization would like to promote.

The reward tokens may be accrued by users and be redeemed for goods and services. In some embodiments, the reward tokens may be redeemed for goods and/or services at an internal storefront or a third-party merchant which accepts the reward tokens as payment. For example, in some embodiments, the store is an internal storefront that sells apparel and goods.

Additionally, or alternatively, the reward tokens may have a public cash value and therefore may be redeemed for cash. For example, in some embodiments, a user may accrue reward tokens and then transfer the cash value associated with the accrued reward tokens to another digital wallet, a bank account, or the like.

Additionally, or alternatively, a reward token transaction to convert reward tokens to a cash value is triggered automatically in response to one or more conditions being met, or can be triggered and distributed as part of a smart contract being executed. For example, the triggering event or execution criteria as part of a smart contract for private reward programs for employees may include, but are not limited to, retirement and/or resignation.

The triggering event or execution criteria of the smart contract may further cause the digital wallet associated with the user to close out. In some embodiments, the reward tokens may be redeemed for an offer, coupon, and/or discount. For example, for public reward systems, reward tokens may be redeemed for an introductory discount on a good or service offered by the organization. If the organization is, for example, and insurance provider, the reward tokens may be redeemed for an introductory discount on an insurance policy.

The system may comprise one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. These electronic or electrical components may be used to carry out certain aspects of the methods described herein. For example, in some embodiments, a user may use a voice bot, chat bot, and/or ChatGPT bots of the system to initiate a reward token transaction, redeem reward tokens, determine an amount of reward tokens in their digital wallet. For example, a voice bot, chat bot, and/or ChatGPT bots of the system may initiate a reward token transaction (e.g., transferring reward tokens and/or redeeming reward tokens) by sending an instruction to the blockchain network in response to an input by a user (e.g., by the user typing “Transfer 100 reward tokens to John Smith” or “How many reward tokens are in my account” in a chat bot associated with the system). The voice bot, chat bot, and/or ChatGPT bots may also retrieve information from the blockchain by sending a request for information to the blockchain.

Additionally, or alternatively, voice bot, chat bot, and/or ChatGPT bots may provide a link which directs the user to a user interface to perform these functions. A voice bot, chat bot, and/or ChatGPT bots may be further configured to request additional information from a user if needed (e.g., “Please enter your wallet address” in response to a request to transfer to transfer 100 reward tokens to John Smith).

In some embodiments, the access computing device described herein is configured to access the blockchain network through a first blockchain node computing device. The access computing device may be further configured to receive (e.g., directly and/or from a user computing device) reward token transactions. Each reward token transaction may include transaction data. Transaction data may include, but is not limited to a number of reward tokens associated with a transaction, a wallet address of the sender, a wallet address of receiver, a transaction ID, a date and/or time of the transaction, a description of the transaction, and/or any other information associated with the transaction. The transaction ID may comprise an alphanumeric string that uniquely identifies transaction within a blockchain.

The access computing device may be configured to transmit the reward token transaction to the nodes of the blockchain network. The nodes of the blockchain network may then validate the transaction using known algorithms. Once verified, the transaction data is used to create a new block of data for the ledger and the new block is then added to the blockchain. In some embodiments, the transaction data may include, but is not limited to, a number of reward tokens associated with a transaction, a wallet address of the sender, a wallet address of receiver, a transaction ID, a date and/or time of the transaction, a description of the transaction, and/or any other information associated with the transaction.

The reward program computer system described herein leverages blockchain technology to enable transactions in reward tokens. The reward program computer system described herein offers the following advantages: (i) distributing the computational requirements of transactions within a reward system; (ii) increasing transparency and access to transactional records within the reward system; (iii) increasing reliability, verifiability, and/or trust of executed transactions within the reward system; (iv) improving data integrity and security of transactions within the reward system; (v) reducing enforcement, administration, and/or clearinghouse time and costs; (vi) providing opportunities for rewards that cannot be erased, cancelled, or expire; and/or (vii) providing a network-based platform for providing rewards.

The methods and systems described herein may be implemented using computer programming or engineering techniques including computer software, firmware, hardware, or any combination or subset thereof, wherein the technical effects may be achieved by performing at least one of the following steps: (a) accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (b) in response to a predetermined criterion being met, automatically generating a reward token transaction, the reward token transaction including transaction data comprising at least a wallet address of a sender, a wallet address of a receiver, and an amount of reward tokens; (c) broadcasting an update to the plurality of node computing devices of the blockchain network, the update including the reward token transaction; (d) validating the reward token transaction; and/or (e) in response to validation of the reward token transaction, generating and storing a new block the blockchain network with the reward token transaction.

### Exemplary Blockchain System to Enable Transactions in Reward Tokens

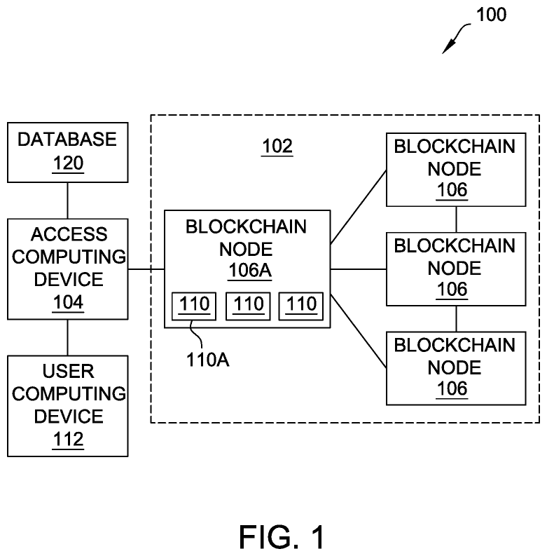

FIG. 1 depicts an exemplary computing environment 100 for implementing a reward program computer system 102 for creating a blockchain that securely and accurately stores and manages reward tokens. Reward program computer system 102 may be used to create a blockchain that for storing and managing reward tokens associated with a company or organization. Transaction information for the reward tokens may be easily retrieved and viewed by multiple parties. In some embodiments, computer system 102 includes an access computing device 104 and at least one blockchain node computing device 106 (also referred to herein as “nodes” 106) of a blockchain network 108. Access computing device 104 is communicatively coupled, such as via wireless communication or data transmission over one or more radio frequency links or digital communication channels, or wired communication, or via an Application Programming Interface (API), to at least one node 106A, and node 106A is communicatively coupled to a plurality of other nodes 106B, such as via wireless communication or data transmission over one or more radio frequency links or digital communication channels, or wired communication.

The plurality of nodes 106 may form blockchain network 108. Each node 106 may store a respective copy of a plurality of blockchains 110. As described further herein, each blockchain 110 may include a sequence of one or more blocks that are cryptographically verifiable and enforce a chronological order of data stored in subsequent blocks, and each block after a first block may include a description of data stored in a previous block and/or a link to the previous block.

As described in more detail, access computing device 104 may be configured to issue, exchange, and redeem reward tokens, by for example, (i) access the blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block; (ii) in response to a predetermined criterion, automatically generate a reward token transaction, the reward token transaction including transaction data comprising at least a wallet address of a sender, a wallet address of a receiver, and an amount of reward tokens; (iii) broadcast an update to the plurality of node computing devices of the blockchain network, the update including the reward token transaction; (iv) validate the reward token transaction; and/or (v) in response to validation of the reward token transaction, generate and store a new block the blockchain network with the reward token transaction.

In some embodiments, the reward tokens are associated with an organization. In further embodiments, the reward tokens are issued to and exchanged amongst users associated with the organization, including, but not limited to employees of the organization, customers of the organization, and/or prospective customers of the organization. In some embodiments, the reward tokens are redeemable for goods and/or services offered by the organization.

A user may interact with access computing device 104 (e.g., directly or indirectly) to view and manage reward tokens. For instance, the user may interact with a website, software application (“app”) or other such platforms to view a balance of reward tokens in a digital wallet, a history of transactions associated with the respective digital wallet, and to initiate a transfer of reward tokens to another digital wallet. In some embodiments, access computing device 104 may be associated with an organization, such that a user may interact with access computing device 104 at a location associated with the organization (e.g., at an office location associated with the organization). Alternatively, access computing device 104 may be associated with a user, such that the user may interact with access computing device 104 substantially any time and/or in any location.

Additionally, or alternatively, a user may use a user computing device 112 to remotely or indirectly interact with access computing device 104. For instance, user may use user computing device 112 to interact with a reward program dashboard on an app or a website, and user computing device 112 may be configured to transmit any input information or requests to access computing device 104 as described herein.

In some embodiments, the reward tokens are stored in a digital wallets associated with the blockchain. The digital wallets may be configured to store, manage, and exchange the reward tokens. A digital wallet for storing, managing, and exchanging reward tokens may be associated with a user, a group of users, and/or an administrator account for the organization. The digital wallet may be run by the organization or by another third party that maintains digital wallets for storing and managing reward tokens. Each digital wallet comprises a wallet address. The wallet address may comprise an alphanumeric string that uniquely identifies a digital wallet. In some embodiments, a wallet address may have an associated alias name that is more user-friendly than the actual wallet address.

The wallet addresses and their associated aliases may be stored in a wallet database, such as database 120 (shown in FIG. 1). A user may look up a wallet address in the wallet database using the alias. The wallet database may be accessible via a user deice, such as access computing device 104 and/or user computing device 112, that is communicatively coupled to the identification database.

Access computing device 104 and/or user computing device 112 may be computers that include a web browser or a software application, which enables access computing device 104 and/or user computing device 112 to access remote computer devices, such as node 106A, using the Internet or other network. More specifically, access computing device 104 and/or user computing device 112 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Access computing device 104 and/or user computing device 112 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In addition, nodes 106 may be computers configured to communicate with one another, using the Internet or other network. More specifically, nodes 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In some embodiments, nodes 106 may be any device capable of accessing the Internet including, but not limited to, a desktop computer, a laptop computer, a personal digital assistant (PDA), a cellular phone, a smartphone, a tablet, a phablet, wearable electronics, smart watch, voice or chat bot, ChatGPT bot, augmented reality or virtual reality headsets or glasses, or other web-based connectable equipment or mobile devices. In other embodiments, nodes 106 may be server computing devices specifically configured to function as blockchain nodes 106.

In some embodiments, access computing device 104 may function as node 106. Accordingly, where reference is made herein to access computing device 104 accessing and/or otherwise communicating with nodes 106 (e.g., with node 106A), it should be understood that such reference may equally refer to access computing device 104 accessing node functionality within access computing device 104 itself.

Access computer device 104 may be further communicatively coupled to a database 120 that stores data. For instance, database 120 may be a local or remote database 120 associated with a reward program and configured to store data not stored in blockchain network 108 and/or store a local copy of certain data stored in blockchain network 108. In some embodiments, database 120 may store one or more smart contracts. In some embodiments, database 120 may store one or more of user data, transaction data, asset data, smart contracts, and/or any other suitable information. In some embodiments, database 120 may be stored remotely from access computing device 104. In some embodiments, database 120 may be decentralized. In some embodiments, a user, such as an employee and/or a customer of an organization, may access database 120 via access computing device 104 and/or another computing device (not shown) associated with the organization.

In one exemplary embodiment of the present disclosure, a reward program computer system (e.g., computer system 102) for managing reward tokens using blockchains may include a first blockchain node computing device (e.g., node 106A) integral to a blockchain network (e.g., blockchain network 108). The blockchain network may include a plurality of blockchain node computing devices (e.g., nodes 106) including the first blockchain node computing device. The first blockchain node computing device may be configured to store a local copy of a plurality of blockchains (e.g., blockchains 110), each blockchain including a sequence of one or more blocks, wherein each block is cryptographically verifiable and enforces a chronological order of data stored in subsequent blocks. Each block after a first block may include a description of data stored in a previous block.

The reward program computer system may also include an access computing device (e.g., access computing device 104) communicatively coupled to the first blockchain node computing device such that the access computing device has access to the plurality of blockchains stored in the blockchain network. The reward system computer system may be configured to: (i) receive, at the access computing device, transaction data for a reward token transaction; (ii) broadcast, from the access computing device to the blockchain nodes, the reward token transaction data; (iii) in response to receiving the broadcast, validating the reward token transaction and the user; (iv) combine the current reward token transaction with previous reward token transactions to create a new block of data for the data; and/or (v) add the new block to the blockchain with the reward token transaction data in an encrypted format.

### Exemplary Blockchain

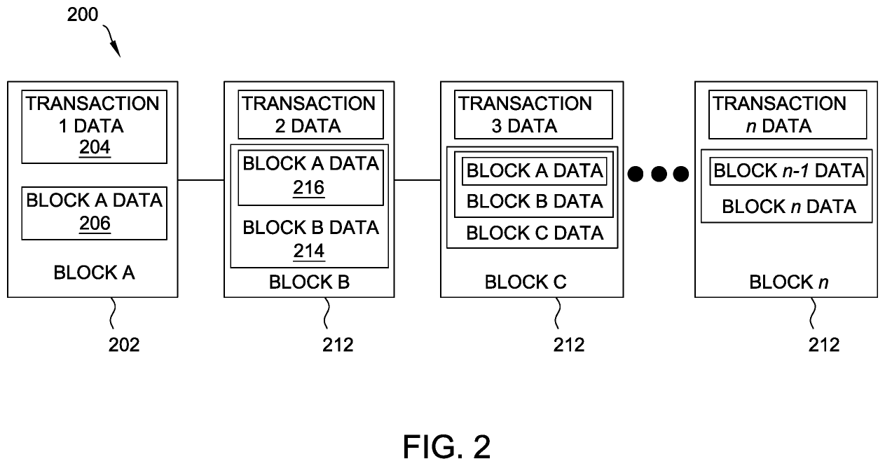

FIG. 2 depicts an exemplary blockchain 110 that may be generated and stored using one or more blockchain nodes 106 of a blockchain network (all shown in FIG. 1). Blockchain network may be a distributed database that maintains a continuously growing blockchain 110, or list, of ordered records, known as blocks 202. Blockchain network may provide an encrypted, distributed, and immutable ledger as blockchains 110 in which transaction information is stored. Each blockchain 110 includes a sequence of one or more blocks 202 that are cryptographically verifiable and enforce a chronological order of data stored in subsequent blocks 202.

In one exemplary embodiment, the one or more blocks 202 may include a first block 402 (referred to as “Block A” in FIG. 2) representing a first transaction associated with reward tokens. In the exemplary embodiment, Block A may store transaction data 204 which may include, but is not limited to a number of reward tokens associated with a transaction, a wallet address of the sender, a wallet address of receiver, a transaction ID, a date and/or time of the transaction, a description of the transaction, and/or any other information associated with the transaction. Block A may further include Block A data 206 associated specifically with Block A. For instance, Block A data 206 may include a timestamp associated with the generation of Block A and/or an identifier of a node 106 at which Block A was generated.

The one or more blocks 202 may additionally include subsequent blocks 212 (referred to individually as “Block B,” “Block C,” through “Block n” in FIG. 2 and collectively as blocks 212). Each subsequent block 212 may include transaction data 204 and block data 206, any of which may be similar to or different from the data stored in Block A. For instance, each subsequent block 212 may include transaction data 204 associated with another transaction. While the embodiment depicted in FIG. 2 each contains one transaction, each block 202, 212 may consist of any number of transactions. For example, each block 202, 212 may include transactions from a particular time interval (e.g., all new blockchain transactions are grouped into a block every 10 minutes). In some embodiments, each transaction is associated with a unique transaction ID that is stored on the respective block.

Each subsequent block 212 may also include block data 214 associated with that corresponding block 212. For subsequent blocks 212, block data 214 may not only include data associated specifically with that block 212 (e.g., timestamp, node 106 identifier) but may further include a description of the previous block 212's data. As one specific example, Block B data 214 may include a description 216 of Block A, wherein description 216 may include a hash of Block A. The hash may be generated by executing a hashing function on the data 204, 206, 208, 210 stored in Block A. This continues on, with each block 212 adding on to the next while containing a hash of the previous block(s) 212 in blockchain 110. In this way, the chronological series of data stored in a single blockchain 110 may be verifiable and immutable.

### Exemplary Process for Managing Reward Tokens

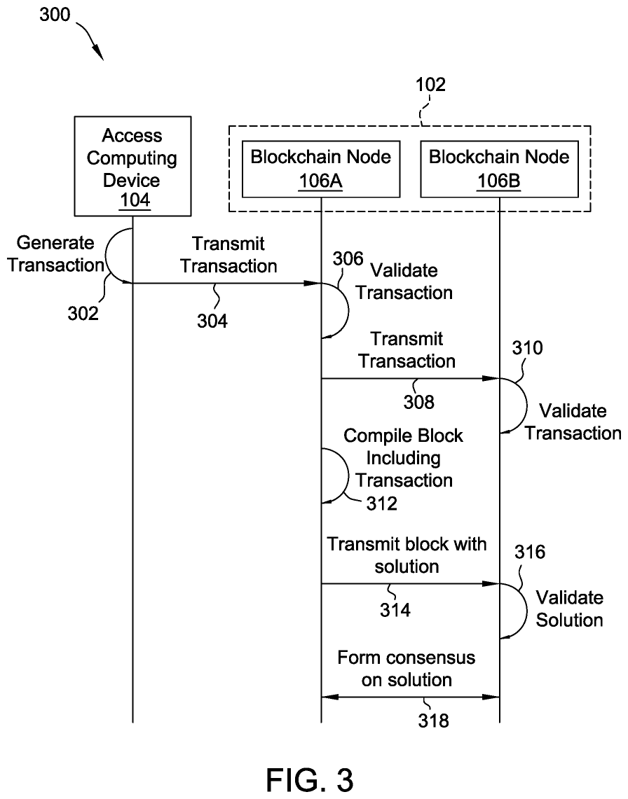

FIG. 3 illustrates an exemplary sequence flow diagram 300 for reward token transactions using a reward program computer system 102 (shown in FIG. 1). Specifically, data flow diagram 300 depicts a process for transferring reward tokens using access computing device 102, a first blockchain node computing device 106A (shown in FIG. 1) and second blockchain node computing device 106B.

As discussed above, access computing device 104 is communicatively coupled to at least one node 106 that is part of a blockchain network (shown in FIG. 1). Each node of the blockchain networks stores a respective copy of a plurality of blockchains 110 (also shown in FIG. 1), and each blockchain 110 may include a sequence of one or more blocks that are cryptographically verifiable and enforce a chronological order of data stored in subsequent blocks, wherein each block after a first block includes a description of data stored in a previous block and/or a link to the previous block. The description of the data in the previous block and/or the link to the previous block may include, in some embodiments, a hash of the previous block generating using a hash function.

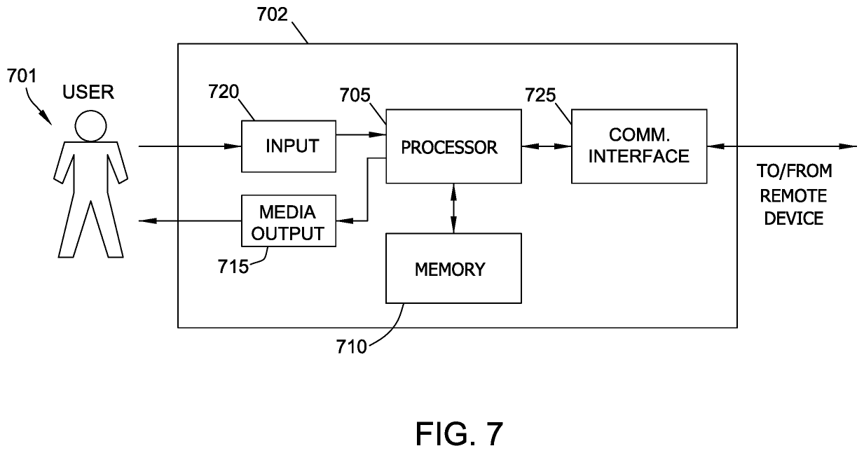

At 302, access computing device 104 generates a reward token transaction. Access computing device 104 transmits the reward token transaction to first node computing device 106A of the blockchain network at 304. The transaction may be initiated by an input received from an input device of user computing device 112 (shown in FIG. 1). Additionally, or alternatively, the transaction may be initiated by an input received by an input device of access computing device 104 (e.g., input device 720, shown in FIG. 7). Each reward token transaction includes transaction data. Transaction data may include one or more of a number of reward tokens associated with a transaction, a wallet address of the sender, a wallet address of the receiver, and/or any other information associated with the transaction.

First node computing device 106A validates the transaction at 306. If the transaction is valid, first node computing device 106A transmits the transaction to a second node computing device 106B of the blockchain network at 308. Second node computing device 106B validates the transaction at 310. If the transaction is valid, second node computing device 106B transmits the transaction to a third node computing device of the blockchain network (not shown), and so on, until every node in the blockchain network has validated the transaction. At 312, once every node has validated the transaction, first node computing device compiles a block including the validated transaction. Compiling the new block may include solving a cryptographic puzzle and linking the block to other blocks, as described above with respect to FIG. 2. First node computing device 106A may transmit the new block to the other nodes in the blockchain network, in this case second node computing device 106B, at 314. In some embodiments, first node computing device 106A and second node computing device 106B validate the solution to the new block at 316. In some embodiments, the nodes of the blockchain network, e.g., first node computing device 106A and second node computing device 106B form a consensus that the solution is valid at 318, thereby forming a consensus on the blocks of transactions stored by all the nodes.

### Exemplary System for Blockchain Mining

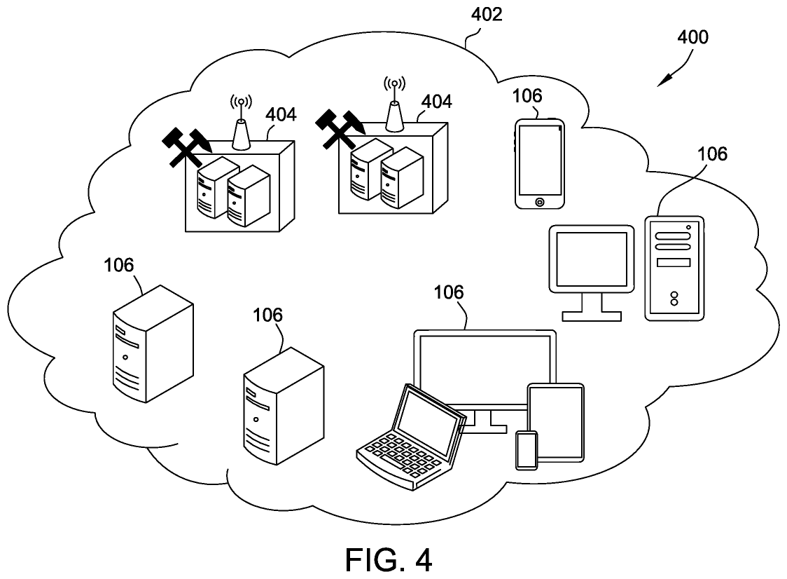

FIG. 4 illustrates a block diagram 400 of an exemplary blockchain mining system 402 in accordance with one embodiment of the present disclosure. Blockchain mining system 402 may be integral to and/or otherwise associated with blockchain network. Blockchain mining system 402 may include a supernode 404 and a plurality of nodes 106 (shown in FIG. 1). Some nodes 106 may just be storing the latest copy of a blockchain 110 (shown in FIG. 1). Other nodes 106 may be miners and are processing blocks 202 (shown in FIG. 2) in blockchain 110.

Supernode 404 monitors blockchain 110 and the integrity of system 402. For example, supernode 404 may monitor when different nodes 106 go offline or become unavailable. Supernode 404 may also add nodes 106 to system 402 and ensure that nodes 106 have up-to-date copies of blockchain 110. System 402 may include a plurality of nodes 106 from a plurality of sources to improve or increase the size and the integrity of each blockchain 110.

In some embodiments, nodes 106 may include one or more access computing device(s) 104 and/or one or more user computing device(s) 112 (shown in FIG. 1). Nodes 106 may additionally or alternatively include other computer devices of an organization. Nodes 106 may also include computer devices, such as servers, workstations, and mobile devices of a blockchain federation or network (e.g., blockchain network) that may extend outside of the control of the organization. In some embodiments, the organization maintains one or more blockchains 110, where each blockchain 110 contains the transactions associated with the reward tokens.

When a new transaction is validated at nodes of a blockchain network, the nodes may wirelessly stream the data to be added to the corresponding blockchain 110. This data may be added to the appropriate blocks 202.

The data may be passed to the various other nodes 106 in system 402, where the data will be stored in blockchains 110 in each of the various nodes 106 storing the blockchain 110. In some embodiments, the data may be transferred and each node 106 generates the next block in the blockchain 110. In other embodiments, the originating node 106 may generate the next block and transmit the block to the other nodes 106. In still other embodiments, supernode 404 may generate the next block and transmit the block to the nodes 106.

### Exemplary Computer-Implemented Process for Managing Reward Tokens

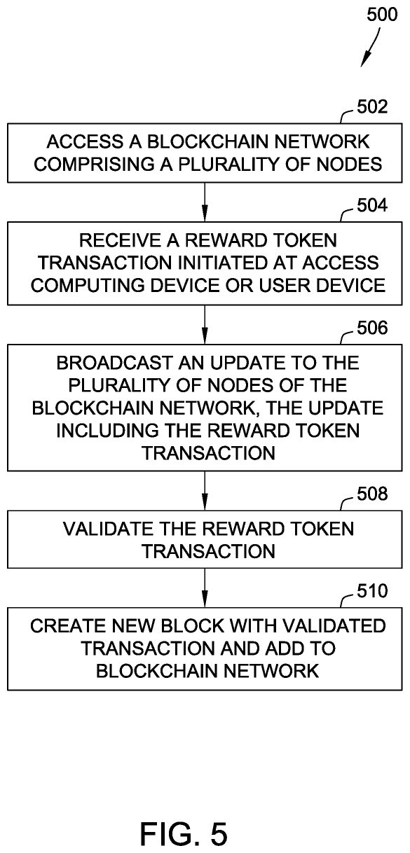

FIG. 5 illustrates a flow chart of an exemplary computer-implemented process 500 for one aspect of sending and receiving reward tokens using the reward program computer system 102 (shown in FIG. 1). One or more steps of process 500 may be implemented using access computing device 104 (also shown in FIG. 1). Additionally, or alternatively, one or more steps of process 500 may be implemented using one or more nodes 106 and/or user computing device 112 (both also shown in FIG. 1).

At 502, process 500 may include accessing a blockchain network through a first blockchain node computing device. The blockchain network may include a plurality of node computing devices that store a respective copy of a plurality of blockchains, each blockchain including a sequence of one or more blocks that are cryptographically verifiable and enforce a chronological order of data stored in subsequent blocks, wherein each block after the first block includes a description of data stored in a previous block.

At 504, process 500 may include receiving a reward token transaction. The transaction may include transaction data. The transaction data may include, but is not limited to, a number of reward tokens associated with a transaction, a wallet address of the sender, a wallet address of receiver, a transaction ID, a date and/or time of the transaction, a description of the transaction, and/or any other information associated with the transaction.

Each digital wallet may possess a wallet address. The wallet address may include a string of random letters and numbers. In some embodiments, a wallet address may have an associated alias name that is more user-friendly than the actual wallet address. The wallet addresses and their associated aliases may be stored in a wallet database, such as database 120 (shown in FIG. 1). A user may look up a wallet address in the wallet database using the alias. The wallet database may be accessible via a user deice, such as access computing device 104 and/or user computing device 112, that is communicatively coupled to the identification database.

In some embodiments, blockchain network may be used to transfer reward tokens from one user to another user. In other words, a user may initiate a transaction of reward tokens. For example, reward tokens may be transferred from a department leader to an employee or from one employee to another employee. In some embodiments, each leader of the organization may be given a number of reward tokens to distribute to employees over a time period. These funds may be held in a department leader's digital wallet. A user may initiate the transfer of reward tokens in response to a user achieving a goal, performing a desirable action, mentoring or assisting another user, outstanding work performance, and/or any other actions the organization would like to promote.

A reward token transaction is triggered automatically in response to one or more conditions being met, or can be triggered and distributed as part of a smart contract being executed. A “smart contract” may be computer code executable upon the satisfaction of one or more execution criteria. A smart contract may be based upon a blockchain structure. For example, the blockchain network may further function to store smart contracts that execute upon satisfaction of one or more execution criteria. Execution of the smart contract may automatically trigger a transfer of reward tokens (e.g., from an organization's administrative wallet to a user wallet).

In some embodiments, the smart contract may be stored in a plurality of locations including the access computing device, a database, and/or the blockchain network. In some embodiments, the smart contract is transmitted to the first blockchain node computing device for storage and distribution to the plurality of other blockchain node computing devices, to update their local copies of the first blockchain with the smart contract.

In some embodiments the execution criteria of smart contracts are set forth by the organization and relate to an activity or event tied to employment. For example, with regard to a reward program that is internal to an organization, an automatic transfer of reward tokens from the organization's administrative wallet to an employee account may occur upon the employee completing a training program, reaching a work anniversary, achieving an objective performance goal, and/or any other objective criterion.

In some embodiments, the reward program computing system receives the activity and event information relating to a smart contract from another computing device or database. Therefore, instead of an employee having to maintain a person list of past achievements, the blockchain network may do it for them. Additionally, or alternatively, the reward program computing system receives the activity and event information relating to a smart contract from a user input.

Further, an organization may automatically send reward tokens to employees upon the organization achieving an objective performance goal, on a certain date such as a holiday, completing a survey, completing a survey, and/or any number of other actions an organization would like to promote within their organization. Upon execution of a smart contract, an update may be sent to the blockchain network, and an automatic transfer of reward tokens may occur.

Automating a reward program process may substantially reduce costs associated with managing a reward program, as well as the instance of human error. Implementing this automation using blockchain technology may eliminate the need to use any third-party technology and may improve security of reward program information due to the decentralized and encrypted nature of blockchain technology, and may facilitate the use of “smart contract” technology hosted in blockchain blocks. The systems and methods herein may further facilitate the execution of these smart contracts automatically, as well as an automatic transfer of reward tokens upon execution of the smart contracts.

With regards to a reward program that is semi-public, an automatic transfer of reward tokens may occur upon behaviors that an organization would like to incentivize. For example, for reward programs that are open to clients of an organization, an automatic transfer of reward tokens from the organization's administrative wallet to a client wallet may occur upon the client registering for an online account, logging into their account a predetermined number of times over a time interval, downloading an application, completing a survey, and/or any number of other client actions an organization would like to promote.

With regard to a reward program that is public, an automatic transfer of reward tokens may occur upon behaviors that an organization would like to incentivize. For example, for reward programs that are open to prospective clients of an organization, an automatic transfer of reward tokens from the organization's administrative wallet to a client wallet may occur upon someone providing personal information such as email address or phone number, signing up for an organization newsletter, signing up for an informational session for the organization, completing a survey, and/or any number of other prospective client actions an organization would like to promote.

At 506, process 500 may include broadcasting an update to the plurality of nodes the blockchain network, the update including the reward token transaction. Next, at 508, the plurality of nodes validates the reward token transaction. Once verified, the reward token transaction data is used to create a new block of data for the ledger and the new block is then added to the blockchain at 510. In some embodiments, the transaction data may include, but is not limited to a number of reward tokens associated with a transaction, a wallet address of the sender, a wallet address of receiver, a transaction ID, a date and/or time of the transaction, a description of the transaction, and/or any other information associated with the transaction. The transaction data may be viewed on a website, software application (“app”) or other such platforms associated with reward tokens.

The reward tokens may be accrued by users and be redeemed for goods and services. In some embodiments, the reward tokens may be redeemed for goods and/or services at an internal storefront or a third-party merchant which accepts the reward tokens as payment. For example, in some embodiments, the store is an internal storefront that sells apparel and goods.

Additionally, or alternatively, the reward tokens may have a public cash value and therefore may be redeemed for cash. For example, in some embodiments, a user may accrue reward tokens and then transfer the cash value associated with the accrued reward tokens to another digital wallet, a bank account, or the like.

Additionally, or alternatively, a reward token transaction to convert reward tokens to a cash value is triggered automatically in response to one or more conditions being met, or can be triggered and distributed as part of a smart contract being executed. For example, the triggering event or execution criteria as part of a smart contract for private reward programs for employees may include, but are not limited to, retirement and/or resignation.

The triggering event or execution criteria of the smart contract may further cause the digital wallet associated with the user to close out. In some embodiments, the reward tokens may be redeemed for an offer, coupon, and/or discount. For example, for public reward systems, reward tokens may be redeemed for an introductory discount on a good or service offered by the organization. If the organization is, for example, and insurance provider, the reward tokens may be redeemed for an introductory discount on an insurance policy.

### Exemplary Graphical User Interface for Reward Program

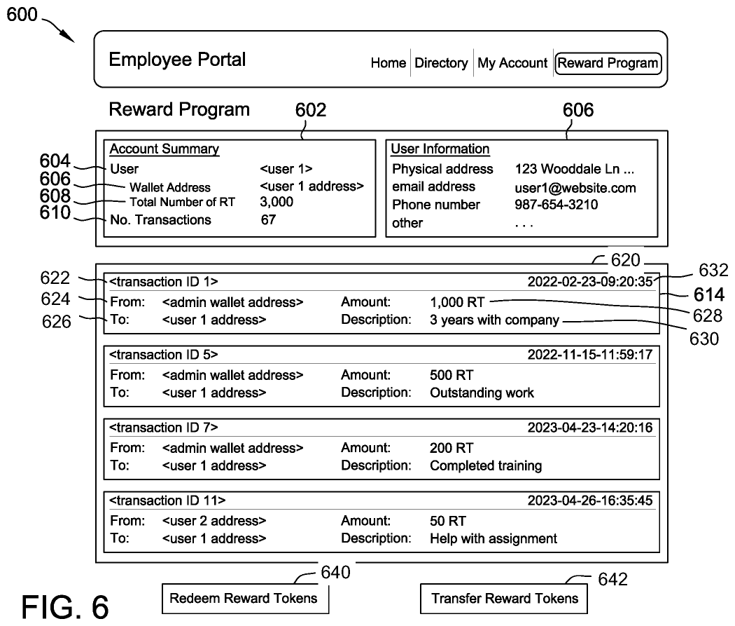

FIG. 6 is a diagram of an exemplary graphical user interface 600 a user account for managing reward tokens, according to an embodiment. The graphical user interface 600 may include account summary information 602. Account summary information 604 may include, but is not limited to, the user's username 604 and wallet address 606, a total number of reward tokens 608 accrued by the user, and the number of transactions 610 the user has been associated with. More or less information may be included in the account summary information 602. The number of transactions 610 may be associated with sending and receiving of reward tokens, purchases made with reward tokens, and/or any other transactions that were made, maintained, and/or stored by the blockchain network of the reward program computing system 102.

In the embodiment of FIG. 6, the graphical user interface 600 further includes user information 612 associated with the user, including, but not limited to, the user's physical address or location, the user's email address, and phone number. However, more or less user information may be included. For example, additional information that further identifies the user on (e.g., an account number, social security number, etc.) may be included.

Graphical user interface 600 further comprises transaction history information 620. Transaction history information 620 may include transaction data associated with each transaction associated with the user. For example, transaction history information 620 may include a transaction ID, a date stamp indicating a date or time at which the transaction was made, a wallet address of the sender, a wallet address of the receiver, an amount of reward tokens that was transferred, and a description including information about the transaction.

For example, reward token transaction 614 includes a transaction ID 622. Transaction ID 622 may comprise an alphanumeric string that uniquely identifies transaction 622 within a blockchain. Reward token transaction 614 also includes a wallet address of the sender 624 and a wallet address of the receiver 626 of the reward tokens. Reward token transaction 614 also includes an amount of reward tokens 628 and a description 630 of the transaction. Reward token transaction 614 may further include a date and time stamp 632 which indicates the data and time at which transaction 614 was executed. As such, reward token transaction 614 involves 1,000 reward tokens which was sent to “user 1” by an administrative account in response to “user 1” reaching 3 years at the company on May 23, 2022.

Graphical user interface 600 of the user account may further comprise links to redeem reward tokens 640 and transfer reward tokens 642. For example, redeem reward token link 640 may redirect user to an internal storefront or a third-party merchant which accepts reward tokens as payment, to a web page or app in which the user can exchange their reward tokens for a cash value, or to a web page or app which includes information for a promotion, offer, or discount. Additionally, or alternatively, a link to may be provided to a user via a chat bot or ChatGPT bots, as discussed above. Transfer reward token link 642 may redirect a user to a graphical user interface for initiating a reward token transaction. Additionally, or alternatively, a link may be provided to a user via a chat bot or ChatGPT bots, as discussed above.

### Exemplary User Computer Device

FIG. 7 illustrates an exemplary configuration of a user computer device 702 that may be used in reward program computer system 102 (shown in FIG. 1). User computer device 702 may be operated by a user 701. User computer device 702 may include, but is not limited to, access computing device 104, blockchain node computing device(s) 106, and/or user computing device 112 (all shown in FIG. 1). User computer device 702 may include a processor 705 for executing instructions. In some embodiments, executable instructions may be stored in a memory area 710. Processor 705 may include one or more processing units (e.g., in a multi-core configuration). Memory area 710 may be any device allowing information such as executable instructions and/or transaction data to be stored and retrieved. Memory area 710 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 705 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 715 may be configured to present a graphical user interface (e.g., a web browser and/or a client application) to user 701. A graphical user interface may include, for example, a fillable form to provide certain transaction data, such as an amount of reward tokens to transfer, a wallet address of the sender, and wallet address of the receiver. In some embodiments, user computer device 702 may include an input device 720 for receiving input from user 701. User 701 may use input device 720 to, without limitation, provide certain transaction data, such as an amount of reward tokens to transfer, a wallet address of the sender, and wallet address of the receiver, for a new reward token transaction. Input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

Stored in memory area 710 are, for example, computer readable instructions for providing a user interface to user 701 via media output component 715 and, optionally, receiving and processing input from input device 720. A user interface may include, among other possibilities, a web browser and/or a client application. Web browsers enable users, such as user 701, to display and interact with media and other information typically embedded on a web page or a website from, for example, an organization. A client application may allow user 701 to interact with, for example, access computing device 104 and/or node(s) 106. For example, instructions may be stored by a cloud service, and the output of the execution of the instructions sent to the media output component 715.

User computer device 702 may also include a communication interface 725, communicatively coupled to a remote device such as access computing device 104, and/or node(s) 106. Communication interface 725 may include, for example, a wired or wireless network adapter and/or a wireless data transceiver for use with a mobile telecommunications network.

### Exemplary Server Computer Device

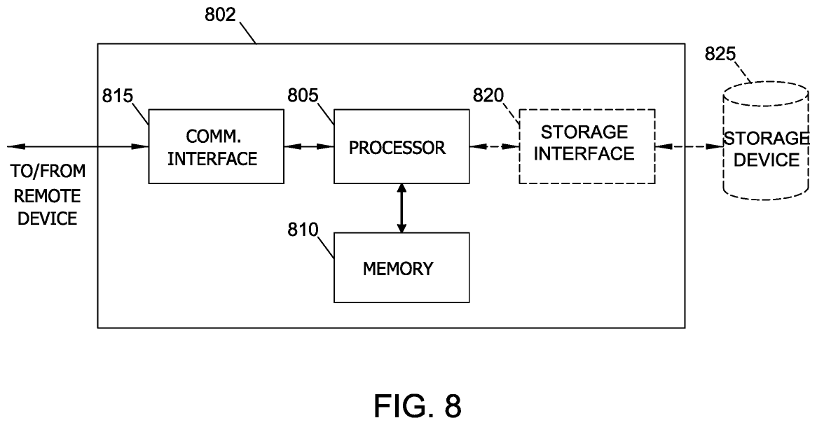

FIG. 8 illustrates an exemplary configuration of a server computer device 802 that may be used in reward program computer system 102 (shown in FIG. 1). Server computer device 802 may include, but is not limited to, access computing device 104 and/or node(s) 106 (both also shown in FIG. 1). Server computer device 802 may include a processor 805 for executing instructions. Instructions may be stored in a memory area 810. Processor 805 may include one or more processing units (e.g., in a multi-core configuration).

Processor 805 may be operatively coupled to a communication interface 815 such that server computer device 802 is capable of communicating with a remote device such as another server computer device 802, a user computer device 702 (shown in FIG. 7), user computing device 112 (shown in FIG. 1), access computing device 104, and/or node(s) 106 (for example, using wireless communication or data transmission over one or more radio links or digital communication channels). For example, communication interface 815 may receive requests from user computer devices 702 via the Internet.

Processor 805 may also be operatively coupled to a storage device 825. Storage device 825 may be any computer-operated hardware suitable for storing and/or retrieving data, such as, but not limited to, data associated with database 120 (shown in FIG. 1). In some embodiments, storage device 825 may be integrated in server computer device 802. For example, server computer device 802 may include one or more hard disk drives as storage device 825. In other embodiments, storage device 825 may be external to server computer device 802 and may be accessed by a plurality of server computer devices 802. For example, storage device 825 may include a storage area network (SAN), a network attached storage (NAS) system, and/or multiple storage units such as hard disks and/or solid state disks in a redundant array of inexpensive disks (RAID) configuration.

In some embodiments, processor 805 may be operatively coupled to storage device 825 via a storage interface 820. Storage interface 820 may be any component capable of providing processor 805 with access to storage device 825. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 805 with access to storage device 825.

Processor 805 may execute computer-executable instructions for implementing aspects of the disclosure. In some embodiments, the processor 805 may be transformed into a special purpose microprocessor by executing computer-executable instructions or by otherwise being programmed. For example, the processor 805 may be programmed with the instruction such as illustrated in FIG. 5.

### Exemplary Computer Device

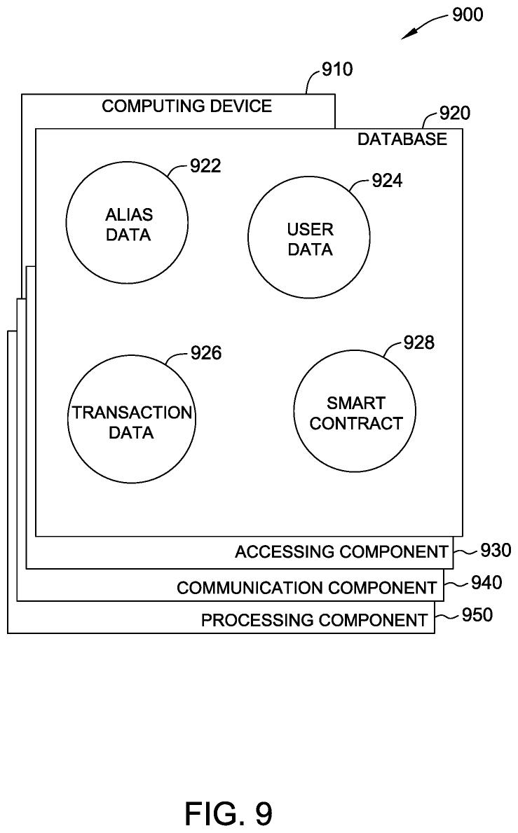

FIG. 9 depicts a diagram 900 of components of one or more exemplary computing devices 910 that may be used in reward program computer system 102 (shown in FIG. 1). In some embodiments, computing device 910 may be similar to access computing device 104 (also shown in FIG. 1). In other embodiments, computing device 910 may be similar to node(s) 106 and/or user computing device 112 (both also shown in FIG. 1). In the exemplary embodiment, computing device 910 may include a database 920 for storing information. For example, database 920 may store alias data 922, user data 924, transaction data 926, smart contracts 928, and/or any other data associated with a reward program. In some embodiments, database 920 is similar to database 120 (shown in FIG. 1).

Database 920 may be coupled with several separate components within computing device 910, which perform specific tasks. Specifically, computing device 910 may include an accessing component 930 enabling access to remote computing devices (e.g., nodes 106). Computing device 910 may also including a communication component 940, for receiving and transmitting transaction and other data. Computing device 910 may further include a processing component 950 to assist with execution of computer-executable instructions associated with reward program computer system 102.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An access computing device for managing reward tokens using a blockchain network, the access computing device comprising at least one processor in communication with at least one memory device, the at least one processor configured to:
access the blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
in response to a predetermined criterion being met, automatically generate a reward token transaction, the reward token transaction including transaction data comprising at least a wallet address of a sender, a wallet address of a receiver, and an amount of reward tokens;
broadcast an update to the plurality of node computing devices of the blockchain network, the update including the reward token transaction;
validate the reward token transaction; and
in response to validation of the reward token transaction, generate and store a new block the blockchain network with the reward token transaction.

2. The access computing device of claim 1, wherein the sender of the reward token transaction is an administrative account.

3. The access computing device of claim 2, wherein the predetermined criterion comprises an objective performance goal being met.

4. The access computing device of claim 1, wherein the predetermined criterion is a predetermined period of time passing, the sender of the reward token transaction is an administrative account, and the receiver of the reward tokens is a designated token distributor.

5. The access computing device of claim 4, wherein the reward token transaction is a first reward token transaction, and the at least one processor is further configured to:
receive a second reward token transaction, the second reward token transaction including transaction data comprising at least a wallet address of a sender, a wallet address of a receiver, and an amount of reward tokens, wherein the sender of the second reward token transaction is the designated token distributor;
broadcast an update to the plurality of node computing devices of the blockchain network, the update including the second reward token transaction;
validate the second reward token transaction; and
in response to validation of the second reward token transaction, generate and store a new block the blockchain network with the second reward token transaction.

6. The access computing device of claim 5, wherein the receiver of the second reward token transaction is an employee or client of a company, wherein the reward tokens are associated with the company.

7. The access computing device of claim 6, wherein the access computing device is communicatively coupled to a database and the at least one processor is further configured to receive an alias of the wallet address of the receiver and perform a lookup of the wallet address of the receiver in the database using the alias of the wallet address of the receiver.

8. The access computing device of claim 1, further comprising causing transaction data associated with the reward token transaction to be displayed on a graphical user interface of the access computing device or a user device communicatively coupled to the access computing device.

9. The access computing device of claim 8, further comprising causing transaction data associated with all reward token transactions associated with a digital wallet to be displayed on a graphical user interface of the access computing device or the user device.

10. A computer-implemented method of operating a computer system to manage reward tokens associated with a company using blockchains, the method implemented using an access computing device of the computer system, the method comprising:
accessing a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
in response to a predetermined criterion being met, automatically generating a reward token transaction, the reward token transaction including transaction data comprising at least a wallet address of a sender, a wallet address of a receiver, and an amount of reward tokens;
broadcasting an update to the plurality of node computing devices of the blockchain network, the update including the reward token transaction;
validating the reward token transaction; and
in response to validation of the reward token transaction, generating and storing a new block the blockchain network with the reward token transaction.

11. The computer-implemented method of claim 10, wherein the sender of the reward token transaction is an administrative account.

12. The computer-implemented method of claim 11, wherein the predetermined criterion comprises an objective performance goal being met.

13. The computer-implemented method of claim 10, wherein the predetermined criterion is a predetermined period of time passing, the sender of the reward token transaction is an administrative account, and the receiver of the reward tokens is a designated token distributor.

14. The computer-implemented method of claim 13, wherein the reward token transaction is a first reward token transaction, and further comprising:
receiving a second reward token transaction, the second reward token transaction including transaction data comprising at least a wallet address of a sender, a wallet address of a receiver, and an amount of reward tokens, wherein the sender of the second reward token transaction is the designated token distributor;
broadcasting an update to the plurality of node computing devices of the blockchain network, the update including the second reward token transaction;
validating the second reward token transaction; and
in response to validation of the second reward token transaction, generating and storing a new block the blockchain network with the second reward token transaction.

15. The computer-implemented method of claim 14, wherein the receiver of the second reward token transaction is an employee or client of the company.

16. The computer-implemented method of claim 15, wherein the access computing device is communicatively coupled to a database, the method further comprising receiving an alias of the wallet address of the receiver and performing a lookup of the wallet address of the receiver in the database using the alias of the wallet address of the receiver.

17. The computer-implemented method of claim 10, further comprising causing transaction data associated with the reward token transaction to be displayed on a graphical user interface of the access computing device or a user device communicatively coupled to the access computing device.

18. The computer-implemented method of claim 17, further comprising causing transaction data associated with all reward token transactions associated with a user to be displayed on the graphical user interface of the access computing device or the user device.

19. A non-transitory computer-readable medium storing instructions for managing reward tokens associated with a company using blockchains, wherein when executed by at least one processor of an accessing computing device, cause the access computing device to:
access a blockchain network through a first blockchain node computing device, the blockchain network including a plurality of node computing devices that store a respective copy of a plurality of blockchains, each blockchain including a sequence of one or more blocks that are cryptographically verifiable and enforce a chronological order of data stored in subsequent blocks, wherein each block after a first block includes a description of data stored in a previous block;
in response to a predetermined criterion being met, automatically generate a reward token transaction, the reward token transaction including transaction data comprising at least a wallet address of a sender, a wallet address of a receiver, and an amount of reward tokens;
broadcast an update to the plurality of node computing devices of the blockchain network, the update including the reward token transaction;
validate the reward token transaction; and
in response to validation of the reward token transaction, generate and store a new block the blockchain network with the reward token transaction.

20. The non-transitory computer-readable medium of claim 19, wherein the instructions, when executed by the at least one processor, further cause the access computing device to:
receiving a second reward token transaction, the second reward token transaction including transaction data comprising at least a wallet address of a sender, a wallet address of a receiver, and an amount of reward tokens, wherein the sender of the second reward token transaction is a designated token distributor;
broadcasting an update to the plurality of node computing devices of the blockchain network, the update including the second reward token transaction;
validating the second reward token transaction; and
in response to validation of the second reward token transaction, generating and storing a new block the blockchain network with the second reward token transaction.
